(19) United States
(12) Patent Application Publication
(10) Pub. No.: US 2012/0068452 A1
(43) Pub. Date: Mar. 22, 2012

(54) Low Profile Collapsible, Expandable, Flexible and Camouflaged Corrugated Downspout Extension and Adapter

(75) Inventor: Eric M. Boettner, Charleston, TN (US)

(73) Assignee: Cleveland Tubing, Inc.

(21) Appl. No.: 13/239,224

(22) Filed: Sep. 21, 2011

Related U.S. Application Data
(60) Provisional application No. 61/385,433, filed on Sep. 22, 2010.

(51) Int. Cl. F16L 21/00; F16L 27/11; F16L 9/14; F16L 37/08; B29C 65/70; F16L 41/00; F16L 55/00

(52) U.S. Cl. 285/45; 285/125.1; 285/145.5; 285/399; 156/245; 138/140

(57) ABSTRACT

A drain pipe coupling for connecting a primary pipe having a primary width ω¹ to two or more secondary pipes, said secondary pipes having a secondary width shorter than the primary width of the primary pipe, said drain pipe coupling having a cuff for connecting to the primary pipe and a transition portion connecting to the secondary openings; a downspout extension terminating in a collapsible, extendable and flexible low profile corrugated discharge pipe having a substantially symmetrical oblong cross section but not having any internal supports; a reducing insert adapter for connecting a 2 inch rectangular downspout to a 4 inch rectangular cuff comprising a first open adapter-end sized to engage with the rectangular cuff and a second open adapter-end sized to engage with the open end of said second rectangular gravity-flow drain pipe; and a gravity-flow drain pipe having a camouflage pattern displayed on a portion of the outer surface of the pipe.

### CROSS-REFERENCE TO RELATED APPLICATIONS

The present application claims priority to and the benefit of the filing date of U.S. Provisional Patent Application Ser. No. 61/385,433 filed Sep. 22, 2010, which is incorporated herein by reference.

### BACKGROUND OF THE INVENTION

This invention relates generally to flexible, collapsible and extendable pipes with standard round or rectangular corrugated bodies, such as are typically used for gravity-flow gutter or landscape drainage systems. In general, this invention is directed towards making such gravity-flow drain pipes less visible to the casual observer, thereby increasing the visual enjoyment of landscaping around a building.

In one aspect, this invention relates to downspout extensions or drain pipe couplings used to divide the flows from a downspout or primary pipe into two or more pipes having a smaller diameter. Smaller diameter secondary pipes are less obtrusive and may be more easily buried or hidden by mulch, pine straw or other landscape materials. Dividing the flow from a single downspout and directing it through a plurality of smaller, flexible corrugated pipes also allows for the runoff water to be discharged over a wider area.

In another aspect, this invention relates to a downspout extension having a flexible, collapsible, and extendable low profile spout section without any internal support structures which can lead to clogging of the spout.

This invention further relates to hiding or reducing the aspect ratio of gravity-flow drain pipes and downspout extensions through the use of a camouflage surface.

When conveying water from the gravity-flow gutter system of a building it is advantageous to use an angled downspout to direct flow away from the walls of the building. It has been found particularly advantageous to use a flexible, extendable corrugated downspout extension to transition from vertical downspout gutter systems which are typically constructed of metal or rigid plastic. A flexible and extendable downspout extension allows the water to be carried further from the foundation before it is either dispersed onto the ground or into an above-ground or underground drainage system. This type of downspout extension product protects the foundation by removing the water from the immediate perimeter of the house. However, erosion and standing water will still be an issue unless the water is conveyed via a landscape drainage system to a storm water system or somehow otherwise dispersed over a larger area of landscape than simply pouring or emptying the entire contents of a downspout at a single spot on the ground.

When underground landscape drainage systems are used to carry runoff water, such systems typically comprise a series of corrugated pipes fitted together to form a contained channel to the desired outlet. Underground drainage systems usually require that large trenches be dug and pipes installed. Such installations are destructive to existing landscaping and expensive to accomplish.

Corrugated pipes used for gravity-flow landscape drainage are typically 4 inches or more in diameter and fashioned from a uniform color of plastic such as the common black or green colored plastic. While functional, the sight of such relatively large, solid-colored man-made objects amongst natural landscape foliage is not aesthetically pleasing.

One solution to this problem that has been created by InvisaFlow, LLC of Alpharetta, Ga. is embodied in its StealthFlow™ low profile downspout extension. The StealthFlow™ downspout extension is a device that provides a flexible transition from a downspout connection to a rigid, straight, low profile pipe or spout section. The low profile pipe section of the StealthFlow™ downspout extension is rigid and not flexible. The low profile pipe section of the StealthFlow™ downspout extension is incapable of being bent from side to side along its radial axes and, in order not to collapse under lateral pressure, is constructed having one or more internal vertical supports or spans. Such supports, while useful to keep the low profile pipe section from not collapsing under heavy downward pressure such as being stepped on, also serve to impede or restrict the flow of water and, more importantly, serve as catch points for debris, such as leaves or pine straw, that may be carried in the water. The presence of such internal vertical supports are a serious limitation of the design of the StealthFlow™ downspout extension because such internal vertical supports quickly lead to a buildup of debris which clogs the pipe, thus slowing or completely stopping the passage of water which, of course, is the primary purpose of the device.

### BRIEF SUMMARY OF THE INVENTION

This invention is an improved system for conveying runoff water and dispersing it into the surrounding landscape with minimal installation and minimal visual interference. In a first aspect, this is accomplished through a novel downspout extension or drain pipe coupling that provides a transition from a conventional 4-inch diameter round primary pipe having a cuff for connection to a downspout to two or more smaller, secondary flexible, collapsible and extendable corrugated pipes. The secondary pipes end in a connecting means, such as a cuffs, collars or connectors, which provide a means for the attachment of one or a series of additional sections or lengths of flexible and extendable corrugated pipes of similar small diameter, hereinafter referred to as dispersal pipes. Alternatively the secondary pipes could end in a female connector for a hose or soaker hose.

Being smaller in diameter, the secondary pipes and attached dispersal pipes require less invasive trenching if they are to be buried, and otherwise have a lower, less visible profile than typical 4 inch or larger corrugated pipes and may be conveniently covered with mulch or pine straw or more easily hidden beneath existing plants. Secondary corrugated pipes and attached dispersal pipes having a smaller diameter are also more resistant to crushing than larger diameter corrugated pipes. By dividing the flow of runoff water into multiple, multi-directional channels created by the attachment of a series of dispersal pipes, the runoff water may be dispersed over a greater surface area of ground than a conventional, single, channel low profile pipe. If desired, one or more lengths of secondary pipes or dispersal pipes may be perforated to allow small amounts of runoff water to seep out along the length of the pipes as runoff water flows through the pipes.

In a second aspect, an improved system for conveying runoff water and dispersing it into the surrounding landscape with minimal installation and a minimized visual impact is accomplished through a novel downspout extension or drain pipe coupling that transitions from a typical 4″ diameter round pipe to a low profile water-way or corrugated pipe having an oblong cross section that is both collapsible, extendable and flexible, yet rigid enough to withstand being covered with landscaping groundcover material such as mulch or pine straw. The oblong secondary corrugated pipe section is symmetrical having rounded or semi-circular corrugated sides and a hollow interior passage that does not have any internal, vertical supports or struts. The presence of such internal supports or struts within the low profile water-way are a serious limitation of the prior art low profile downspout extension as such projections into the interior space of the low profile pipe proved catch points for debris, leading to blockage of the pipe.

In another aspect of the present invention, a reducing insert drain pipe connector or adapter is provided to serve as a connection between a standard 2 inch rectangular gutter downspout and a pipe part having a rectangular cuff sized to connect to a 4 inch rectangular gutter drain pipe.

In another aspect of the present invention, the visual aspect ration of gravity-flow drain pipes may be reduced by camouflaging the outer surface so that the pipers are less noticeable to the casual viewer.

The camouflaging aspect of this invention may be accomplished in a number of conventional ways such as texturing the molds to create variations in the surface of the part, hydrographic printing, silk screening, spray painting, using multiple colored plastics with variations in melt temperature, in-mold labeling, applying coverings made from fabrics, non-wovens or plastics (such as shrink sleeves), embedding foreign materials in the surface of the plastic, or a combination of these methods.

### BRIEF DESCRIPTION OF THE DRAWINGS

The particular features and advantages of the invention as well as other objects will become apparent from the following description taken in connection with the accompanying drawings in which:

FIG. 1 is a perspective view of a drain pipe coupling according to the present invention.

FIG. 2 is a perspective view of an alternate embodiment of the drain pipe coupling according to the present invention having a rectangular cuff and a collapsible and expandable corrugated pipe section between the primary opening and the transition portion.

FIG. 3 is a perspective view of an alternate embodiment of a drain pipe coupling according to the present invention having a transition portion integrally molded with a plurality of collapsible and expandable corrugated pipe sections between the transition portion and the secondary openings.

FIG. 4 is a perspective view of a downspout extension for connecting a primary pipe to a single, low profile discharge pipe having a collapsible and extendable corrugated body with a symmetrical oblong cross section according to the present invention.

FIG. 5 is a front cross-section view of the low profile discharge pipe of FIG. 4 taken along the line A-A.

FIG. 6 is a perspective view of an adapter for connecting together differently sized gravity-flow drain pipes according to the present invention.

FIG. 7 is a perspective view of a prior art downspout extension having a camouflage pattern displayed on the outer surface.

### DETAILED DESCRIPTION OF THE INVENTION

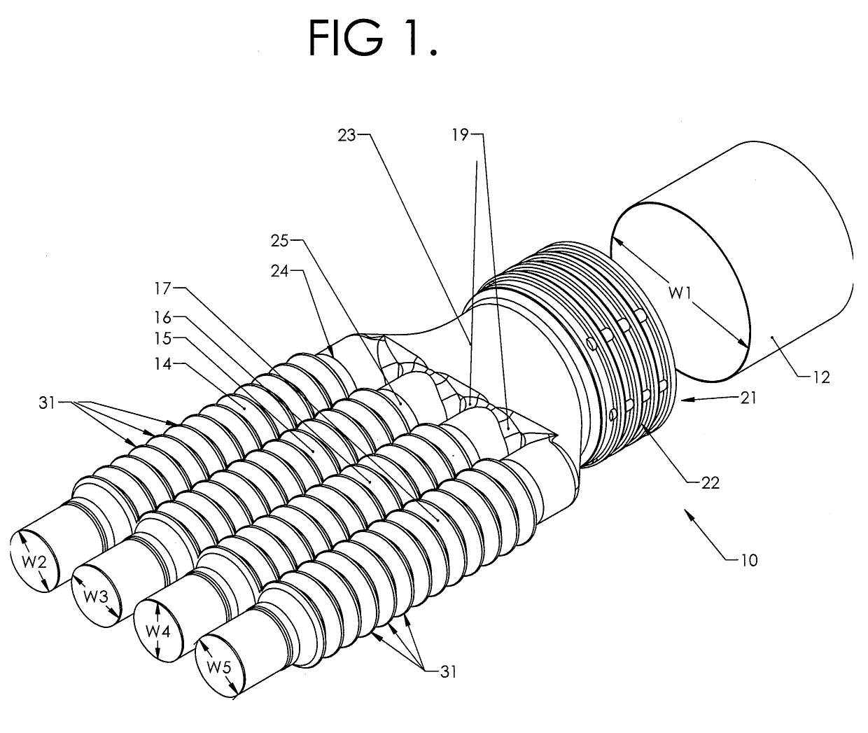

A plastic drain pipe coupling 10 according to the present invention is illustrated in FIG. 1. Drain pipe coupling 10 is useful for connecting a primary pipe 12 having a primary width ω¹ to two or more, smaller or narrower secondary pipes 14, 15, 16, 17. Primary pipes 12 are typically 4 inches or more in diameter with size increments determined according to industry custom. Drain pipe coupling 10 may suitably be formed using blow molding processes familiar in the art. Other manufacturing methods may also be suitable for forming a drain pipe coupling 10 in accordance with the teachings of the present invention.

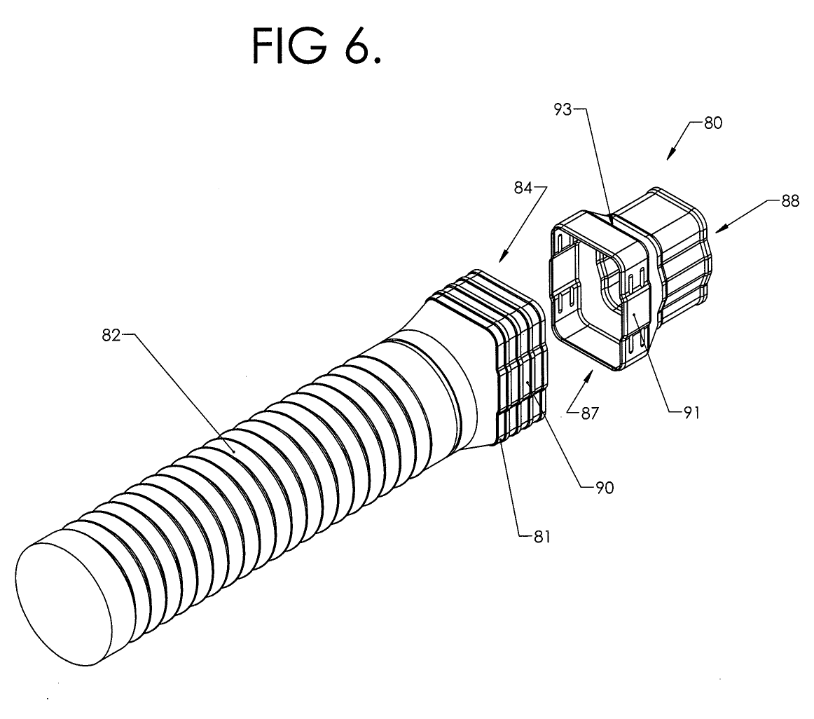

Drain pipe coupling 10 is configured with a primary opening 21 surrounded by a primary pipe cuff 22 sized for connecting to a primary pipe such as downspout 12. The primary pipe cuff 22 may be sized for connection to a round or rectangular downspout 12. In one preferred embodiment not shown in FIG. 1, the primary pipe cuff 22 cuff surrounding the primary opening 21 may be rectangular with a stepped design for connecting to more than one size of primary pipe 12. In another alternate embodiment shown in FIG. 6, and discussed in more detail below, the primary pipe cuff 81 surrounding the primary opening 84 may be rectangular and of a first width and a reducing insert or adapter 80 is provided for engagement with the primary pipe cuff 81 and further engagement to a drain pipe 82 having a second width smaller than the first width of the primary pipe cuff 81.

Returning to FIG. 1, a hollow transition portion 23 forms a connection between the primary opening 21 and a plurality of secondary openings 24, 25, 26, 27 which are shown in FIG. 1 as being connected to secondary pipes 14, 15, 16, 17, respectively. Transition portion 23 is formed of a suitable rigid plastic as is well known in the art.

Secondary pipes 14, 15, 16, 17 each have a secondary width, ω², ω³, ω⁴, and ω⁵, respectively, which is shorter or smaller than the primary width ω¹ of the primary pipe 12. Preferably secondary pipes are about 2 inches or smaller in diameter and not more than about 3 inches in diameter to achieve the low profile purpose of this invention. The transition portion 23 provides a rigid transition of the body of the drain pipe coupling 10 from about the width ω¹ of the primary pipe 12 (which is typically about 4 inches) to the width ω², ω³, ω⁴, ω⁵ of the secondary pipes 14, 15, 16, 17. The internal bore or internal surface (not shown) of the transition portion 23 is relatively smooth to form a clear path for the flow of water, but there will necessarily be some surface variations or geometry 19, both internally and externally, about the secondary openings 24, 25, 26, 27.

Note that it is not required for purposes of the present invention that all secondary pipes 14, 15, 16, 17 be of the same width ω², ω³, ω⁴, ω⁵. For example and not by way of limitation, one secondary pipe 14 could have a width ω² of about 3 inches and the other secondary pipes 15, 16, 17 could have widths ω³, ω⁴, ω⁵ of about 2 inches. Such an embodiment might be useful where the user desired to divert a larger portion of the runoff water to an underground drainage system through the 3 inch secondary pipe 14 while utilizing the smaller portions of runoff water carried through the other secondary pipes 15, 16, 17 to discharge or connect to soaker pipes for discharge through a flower bed for watering purposes.

Preferably secondary pipes 14, 15, 16, 17 have a plurality of collapsible corrugations 31 along the majority of the axial length of the secondary pipe 14, 15, 16, 17 which allow the secondary pipes 14, 15, 16, 17 to be expanded axially along the axis of a secondary pipe to a full length or shortened axially by collapsing all or a number of the corrugations 31. Collapsible and expandable corrugations 31 additionally allow for the secondary pipes 14, 15, 16, 17 to be flexible radially (i.e., in the direction of a radius of a pipe) so that curves in the pipes 14, 15, 16, 17 can be created. The use of flexible secondary pipes 14, 15, 16, 17 is more preferable than inflexible or rigid secondary pipes (not shown) because the use of flexible secondary pipes 14, 15, 16, 17 provides additional functionality by allowing the plurality of secondary pipes 14, 15, 16, 17 to be bent or curved and directed towards different destinations. Thus, water flowing from the primary pipe 12 into the drain pipe coupling 10 is divided into portions as it passes through the secondary openings 24, 25, 26, 27 and into attached secondary pipes 14, 15, 16, 17, each of which can direct a portion of the water to widely scattered destinations. Division of the flow of water allows, in the most basic of applications, for the runoff water to be released upon a plurality of separate and distinct areas about the grounds, thus reducing the concentration or amount of runoff at the release point when compared with prior low profile downspouts.

Preferably the drain pipe coupling 10 comprises at least two secondary openings 24, 27, and most preferably, the drain pipe coupling 10 comprises at least four secondary openings 24, 25, 26, 27. Each secondary opening 24, 25, 26, 27 is sized for connecting to a secondary pipe 14, 15, 16, 17.

In one preferred embodiment, the drain pipe coupling 10 of the present invention may be formed having secondary pipes 14, 15, 16, 17 formed or molded as part of and integral to the secondary openings 24, 25, 26, 27. Such integrally formed secondary pipes 14, 15, 16, 17 would not be removeable from the drain pipe coupling 10.

In another preferred embodiment, the drain pipe coupling 10 may be formed separately from the secondary pipes 14, 15, 16, 17. In such an embodiment, a means for releasably connecting a secondary pipe 14, 15, 16, 17 is associated with each secondary opening 24, 25, 26, 27 and the secondary openings 24, 25, 26, 27 are adapted to receive a detachable secondary pipe 14, 15, 16, 17. Means for releasably connecting a secondary pipe 14, 15, 16, 17 to a secondary opening are well known in the art, with snap-fit engagements, interlocking tabs, mating threads, or other interlocking cuff configurations being some of the most common, but not the exclusive list of such means. Commercially, such an embodiment may be more preferable as interchangeable secondary pipes 14, 15, 16, 17 can be mass produced. A plurality of identical secondary pipes 14, 15, 16, 17 may be connected in series to function as dispersal pipes (not shown), with end-to-end connections such as male and female end cuffs or male and female end threads, thereby allowing a user to join a plurality of additional secondary pipes/dispersal pipes (not shown in FIG. 1) to each of the secondary pipes 14, 15, 16, 17 that connect to the drain pipe coupling 10.

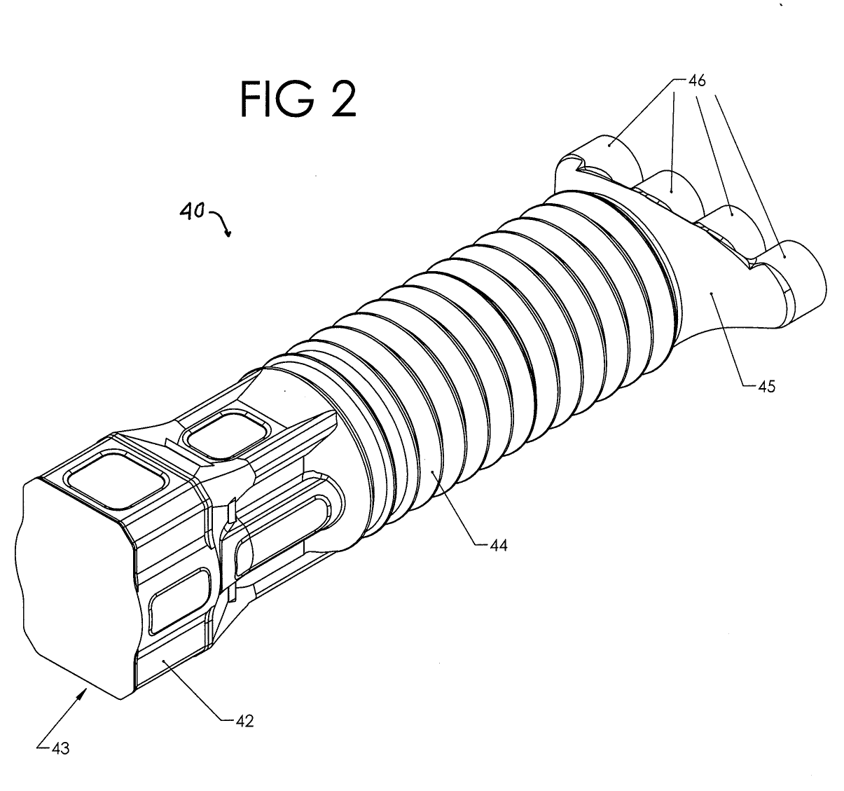

FIG. 2 is a perspective view of an alternate embodiment of a drain pipe coupling 40 according to the present invention having a rectangular cuff 42 with a stepped design for connecting to more than one size of primary pipe (not shown) surrounding the primary opening 43, and a collapsible and expandable corrugated pipe section 44 between the primary opening 43 and the transition portion 45. Transition portion 45 has a plurality of smaller secondary openings 46, each capable of connection with a secondary pipe (not shown).

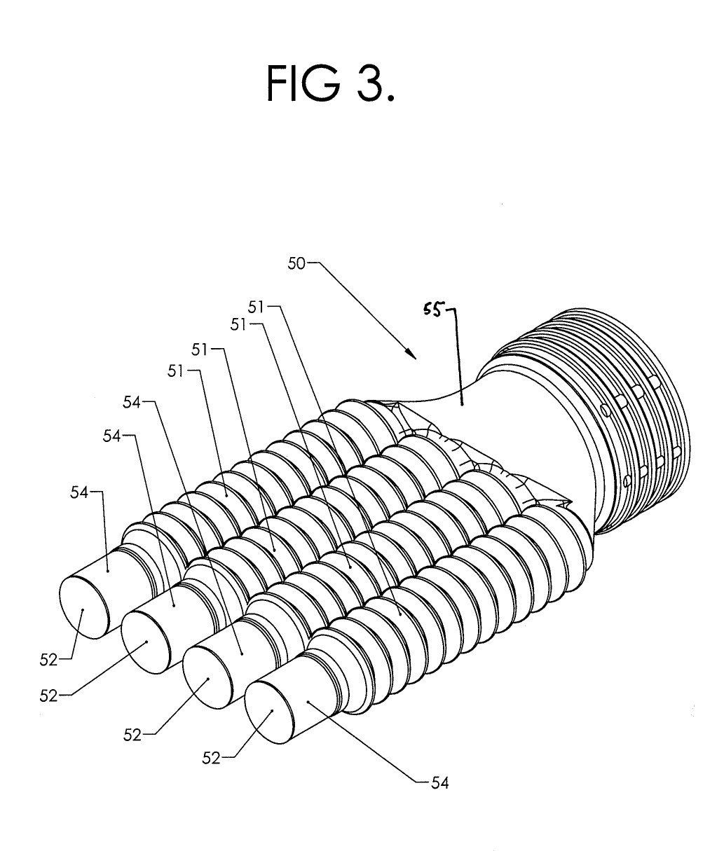

FIG. 3 is a perspective view of an alternate embodiment of a drain pipe coupling 50 having a transition portion integrally molded with a plurality of collapsible and expandable corrugated pipe sections 51 between the transition portion 55 and the secondary openings 52. Secondary openings 52 are surrounded by a cuff 54 for connecting to additional dispersal pipes (not shown).

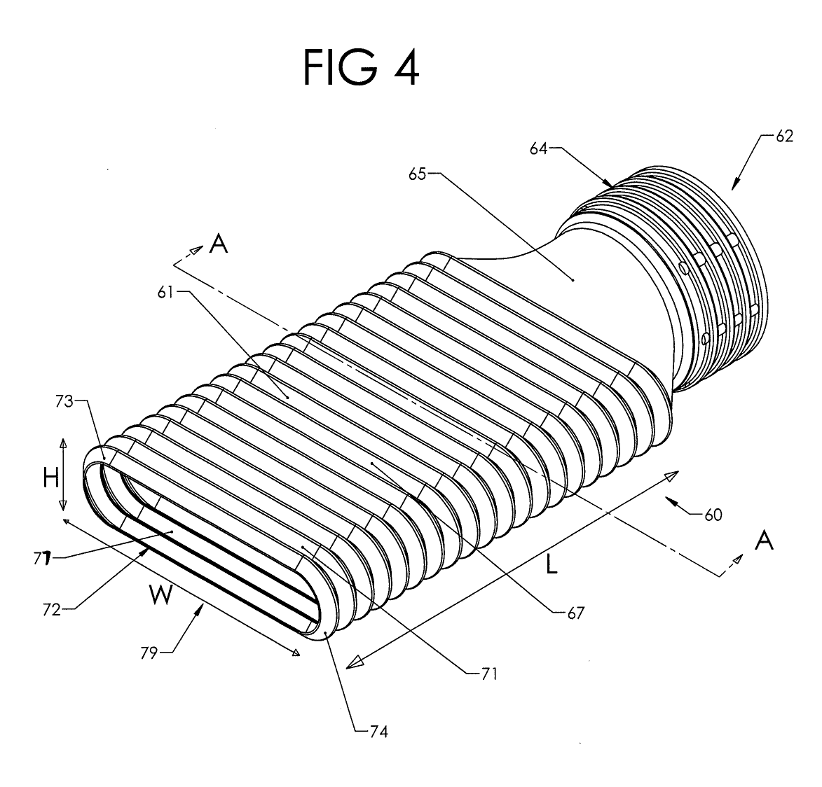

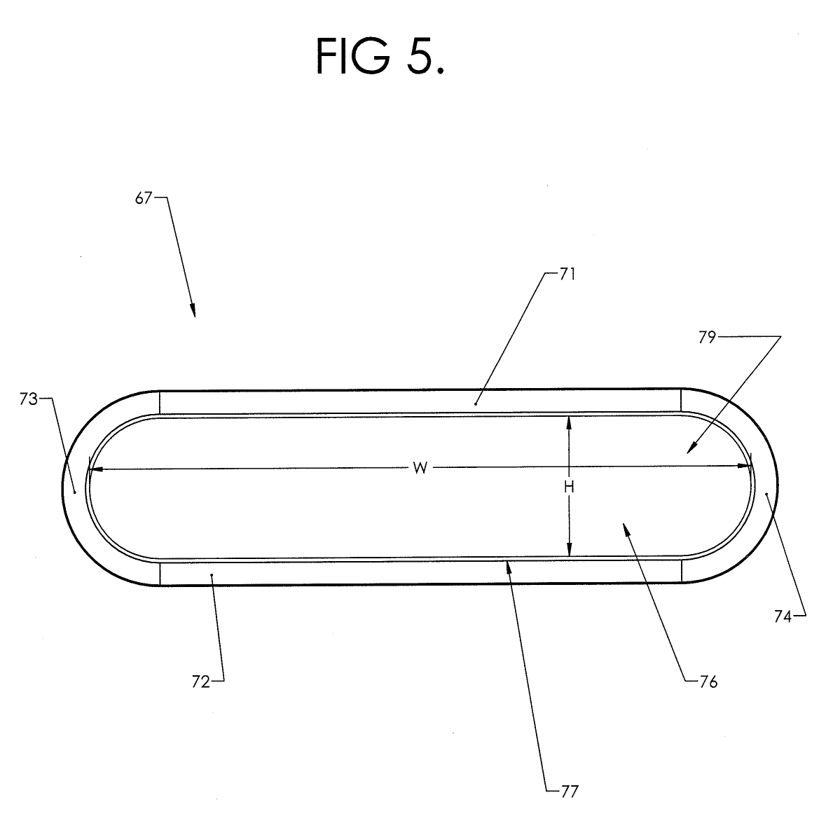

FIGS. 4 and 5 illustrates a downspout extension 60 for connecting a primary pipe 12 (not shown), to a single, low profile discharge pipe 61 having a collapsible and extendable corrugated body 67 with a symmetrical oblong cross section. In order for the corrugated body 67 to be collapsible, extendable, and flexible, the cross section must be symmetrical. An inlet 42 surrounded by a coupling cuff 44 sized for connecting to the primary pipe 12 is connected to a transition portion 65 forming a connection between the primary opening 12 and the low profile discharge pipe 61. The low profile discharge pipe 61 terminates in an outlet 79 opposite the transition portion 65.

The low profile discharge pipe 61 has a flexible, collapsible and extendable corrugated body 67 having a length L and, as shown in FIG. 5, a substantially symmetrical oblong cross section defined by a substantially flat top section 71 and a substantially flat bottom section 72 substantially parallel to the flat top section 71, a first substantially symmetrical non-linear side section 73 and a second substantially symmetrical non-linear side section 74. The top sections 71 and bottom section 72 are joined on a first side by the first substantially symmetrical non-linear side section 73 and on a second side by the second substantially symmetrical non-linear side section 74. In one embodiment, the first and second substantially symmetrical non-linear side sections 73, 74 are substantially semi-circular as illustrated in FIG. 4. Other, more angled or pointed substantially symmetrical non-linear side sections may also be used, but such variable shapes may be less useful in terms of being more difficult to expand, collapse or flex. Thus it can be seen that the interior surface 77 of the corrugated body 67 of the low profile discharge pipe 61 defines a hollow interior space 76 along the length L of the low profile discharge pipe 61. The distance between the top section 71 and bottom section 72 define a height H of the low profile discharge pipe 61, and the distance between the first side section 73 and the second side section 74 define a width W of the low profile discharge pipe 61. Within the interior surface 77 of the corrugated body 67, the hollow interior space 76 is devoid of any internal supports between the substantially flat top section 71 and the substantially flat bottom section 72.

Preferably the height H of the low profile discharge pipe 67 is about 2 inches and not more than about 3 inches to achieve the low profile purpose of this invention. The transition portion 65 provides a rigid transition of the downspout extension 60 from about the width ω¹ of the primary pipe (typically about 4 inches) to the height H and width W of the low profile discharge pipe 67. Preferably the width W of the low profile discharge pipe 61 is not more than about 10 inches and preferably not more than about 8 inches. As the width W of the low profile discharge pipe 61 increases, its ability to support the weight of covering materials is reduced, leading to the potential for more deformation or collapsing of the low profile discharge pipe 61

The corrugated body 67 allows the low profile discharge pipe 61 to be expanded or collapsed in axial length, as well as for radial flexibility to form a curve so that the discharge of runoff water through the outlet 79 may be directed to either side, or higher or lower to follow the contour of the ground (though obviously, elevating the outlet 79 is undesirable as that would tend to result in water backing up in the downspout extension 60).

Because the hollow interior space 76 does not contain any internal support structures or other projections between the substantially flat top section 71 and the substantially flat bottom section 72 as is found in the prior art, runoff water and the debris carried by it are significantly less likely to catch and clog the low profile discharge pipe 61.

In one alternate embodiment of the downspout extension 60 of the present invention (not shown), a collapsible and expandable corrugated pipe section (not shown) is connected in between the inlet 62 and the transition portion 65.

The coupling cuff for primary pipe 64 surrounding the inlet 62 of downspout extension 60 is sized for connecting to a primary pipe 12. The coupling cuff 64 may be sized for connection to a round or rectangular downspout 12. In one preferred embodiment not shown in FIG. 4, the coupling cuff 64 may be rectangular with a stepped design for connecting to more than one size of primary pipe 12.

FIG. 6 illustrates a novel coupling adapter or reducing insert drain pipe connector 80 useful in connection with the present invention as a primary pipe cuff 22 for the drain pipe couplings 10, 40, 50 shown in FIGS. 1, 2 and 3, or as a coupling cuff 64 for the downspout extension 60 shown in FIG. 5, or as a coupling means for most rectangular gravity-flow drain pipes and fittings for rectangular gravity-flow drainage systems.

As shown in FIG. 6, a section of drain pipe 82 has a primary opening 84 surrounded by a primary rectangular cuff 81 sized to engage with an open end of a standard 4 inch wide gravity-flow drain pipe (not shown). The adapter 80 has a first open adapter-end 87 sized to engage or mate with the rectangular cuff 81. The adapter 80 has a second open adapter-end 88 sized to engage or connect with the open end of a second standard 2 inch rectangular drain pipe (not shown). An elongate body comprising surrounding outer walls 93 defines a passage between the first open adapter-end 87 and the second open adapter-end 88.

The primary rectangular cuff 81 and adapter 80 may suitably employ any number of conventional cooperating locking mechanisms for affixing the first open adapter-end 87 of the adapter 80 to the primary rectangular cuff 81. Similarly, the open end of the second rectangular gravity-flow drain pipe (not shown) and the second open adapter-end 88 of the adapter 80 may suitably employ any number of conventional cooperating locking mechanisms for affixing the second open adapter-end 88 of the adapter 80 to the open end of the second rectangular gravity flow drain pipe (not shown). Such locking mechanisms include, but are not limited to the illustrated male 91 and female 90 slots or catches on opposing sides of the first open adapter-end 87 of adapter 80, or alternate snap-fit engagements, tabs, mating threads, interlocking cuff configurations with ridges or other locking mechanisms well known in the art.

Preferably, the first open adapter-end 87 is sized to slidably engage into the primary rectangular cuff 81 as water will typically flow downward from the adapter 80 into the connected drain pipe 82. Nesting the edges of the adapter 80 into the rectangular cuff 81 reduces the likelihood of water escaping at the junction between the adapter 80 and the rectangular cuff 81.

Similarly, it is preferable for the said second open adapter-end 88 to be sized to slidably receive and engage the open end of the second rectangular gravity-flow drain pipe (not shown).

Thus it can be seen that the reducing insert downspout connector 80 of the present invention provides a novel device for connecting a 2 inch rectangular downspout (not shown) to a corrugated pipe 82 having a primary rectangular cuff 81 sized to connect to a 4 inch rectangular downspout (not shown).

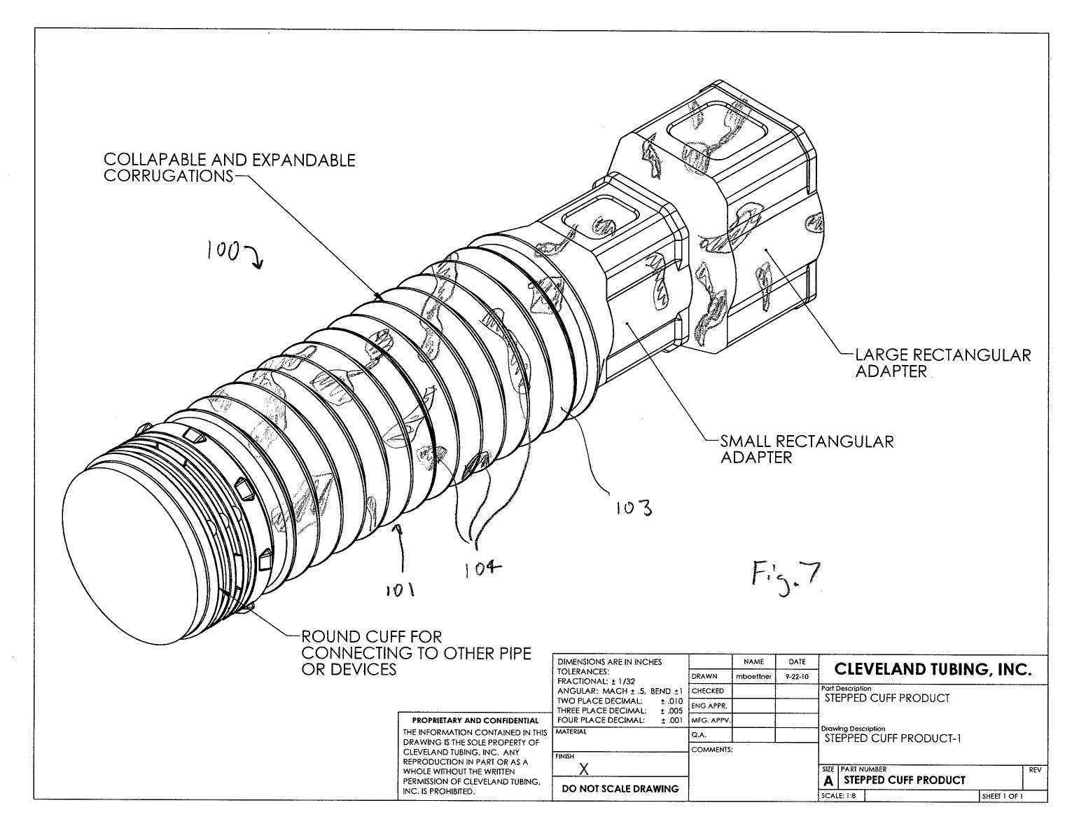

FIG. 7 is a perspective view of a prior art gravity-flow drain pipe 100 having a camouflage pattern 101 displayed on a portion of the outer surface 103 of the pipe 100. The entire outer surface 103 of the part 100 need not display the camouflage pattern 101, though the bigger to portion of the outer surface 103 that does not display a camouflage pattern, the less effective the concealment effect.

The use of camouflage patterns 101 to conceal personnel and objects from view by making them appear to be part of the natural surroundings is well known, but has not been applied in the field of gravity-flow drain pipes and related systems. The camouflage pattern 101 serves to provide concealment by disguising the gravity flow drain pipe 100 such as by making it blend into the color scheme of the natural surroundings and by breaking up or masking the visual silhouette of the device 101.

A camouflage patter 101 typically comprises a plurality of splotches 104 of different colors, typically greens, browns, tans, and shades of black so as to make the device 101 as indistinguishable as possible from the surrounding environment. The desired combination of colors used in the camouflage pattern 101 may be selected to provide a desired camouflage pattern that will blend into the users' landscape. If desired, gravity-flow drain pipes 100 and associated parts and couplings (not shown) may be manufactured having a number of different camouflage patterns 101 to provide a selection for the user.

Producing a gravity-flow drain pipe 100 displaying a camouflage pattern 101 on a portion of the outer surface 103 may be accomplished in a number of conventional methods such as texturing the molds to create variations in the surface of the part, hydrographic printing, silk screening, spray painting, using multiple colored plastics with variations in melt temperature, in-mold labeling, applying coverings made from fabrics, non-wovens or plastics (such as shrink sleeves), embedding foreign materials in the surface of the plastic, or a combination of these methods. Other methods of producing a camouflage pattern 101 on a portion of the outer surface 103 of a gravity-flow drain pipe 100 are within the contemplation of this invention.

A gravity-flow drain pipe 100 may also be camouflaged by providing an outer covering about the coupling, said covering having a camouflage pattern.

With the addition of camouflage colors or covers, gravity-flow drain pipes 100 can blend into the landscape without the need for burial.

Although this invention has been disclosed and described in its preferred forms with a certain degree of particularity, it is understood that the present disclosure of the preferred forms is only by way of example and that numerous changes in the details of operation and in the combination and arrangement of parts may be resorted to without departing from the spirit and scope of the invention as hereinafter claimed.

Having thus set forth the nature of the invention, I claim:

1. A drain pipe coupling for connecting a primary pipe having a primary width to two or more secondary pipes, said secondary pipes having a secondary width shorter than the primary width of the primary pipe, said drain pipe coupling comprising:
(a) a primary opening surrounded by a cuff sized for connecting to the primary pipe;
(b) a transition portion forming a connection between the primary opening and at least two secondary openings, each such secondary opening sized for connecting to a secondary pipe.

2. The drain pipe coupling of claim 1 further comprising a secondary pipe connected to one of said secondary openings.

3. The drain pipe coupling of claim 2 wherein the secondary pipe further comprises a collapsible, expandable and flexible corrugated pipe section.

4. The drain pipe coupling of claim 1 further comprising a secondary pipe integrally molded to at least one of said secondary openings.

5. The drain pipe coupling of claim 1 further comprising a cuff surrounding one of said secondary openings.

6. The drain pipe coupling of claim 1 further comprising a collapsible and expandable corrugated pipe section between the primary opening and the transition portion.

7. The drain pipe coupling of claim 1 further comprising a collapsible and expandable corrugated pipe section between the transition portion and at least one of said secondary openings.

8. The drain pipe coupling of claim 1 wherein the cuff surrounding the primary opening is rectangular.

9. The drain pipe coupling of claim 8 with a stepped design for connecting to more than one size of primary pipe.

10. The drain pipe coupling of claim 1 wherein the cuff surrounding the primary opening is rectangular and is adapted to receive a reducing insert for connecting to a primary pipe having a primary width of a different size.

11. The drain pipe coupling of claim 1 further comprising an outer surface displaying a camouflage pattern.

12. The drain pipe coupling of claim 11 wherein the method of producing said drain pipe coupling is selected from the group consisting of texturing a mold for the pipe to create variations in the outer surface of the pipe, hydrographic printing, silk screening, spray painting, using multiple colored plastics with variations in melt temperature, in-mold labeling, applying coverings made from fabrics, applying coverings made from non-wovens, applying coverings made from plastic, embedding foreign materials in the outer surface of the pipe, or a combination of such methods.

13. The drain pipe coupling of claim 1 further comprising an outer covering about the coupling, said covering having a camouflage pattern.

14. A downspout extension for connection to a primary pipe, said primary pipe having a primary width, said downspout extension comprising:
(a) an inlet surrounded by a coupling cuff sized for connecting to the primary pipe;
(b) a transition portion forming a connection between the primary opening and a low profile discharge pipe, said low profile discharge pipe comprising:
(i) a collapsible and extendable corrugated body having a length and a substantially symmetrical oblong cross section defined by a substantially flat top section, a substantially flat bottom section, a first substantially symmetrical non-linear side section and a second substantially symmetrical non-linear side section;
(ii) a hollow interior space defined along the length of the low profile discharge pipe by the substantially flat top section, the substantially flat bottom section, the first substantially symmetrical non-linear side section and the second substantially symmetrical non-linear side section, said hollow interior space being devoid of any internal supports between the substantially flat top section and the substantially flat bottom section; and
(iii) an outlet opposite the transition portion.

15. The downspout extension of claim 14 wherein said first substantially symmetrical non-linear side section comprises a substantially semi-circular side section and said second substantially symmetrical non-linear side section comprises a substantially semi-circular side section.

16. The downspout extension of claim 14 wherein the collapsible and extendable corrugated body is radially flexible to form a curved pipe.

17. The downspout extension of claim 14 further comprising a collapsible and expandable corrugated pipe section between the inlet and the transition portion.

18. The downspout extension of claim 14 wherein the coupling cuff surrounding the inlet is rectangular with a stepped design for connecting to more than one size of primary pipe.

19. The downspout extension of claim 14 wherein the coupling cuff surrounding the inlet is rectangular and is adapted to receive a reducing insert for connecting to a primary pipe having a primary width of a different size.

20. The downspout extension of claim 14 further comprising an outer surface displaying a camouflage pattern.

21. The downspout extension of claim 20 wherein the method of producing said downspout extension is selected from the group consisting of texturing a mold for the pipe to create variations in the outer surface of the pipe, hydrographic printing, silk screening, spray painting, using multiple colored plastics with variations in melt temperature, in-mold labeling, applying coverings made from fabrics, applying coverings made from non-wovens, applying coverings made from plastic, embedding foreign materials in the outer surface of the pipe, or a combination of such methods.

22. The downspout extension of claim 1 further comprising an outer covering about the coupling, said covering having a camouflage pattern.

23. An adapter for connecting together (i) a first rectangular gravity-flow drain pipe having a rectangular cuff sized to engage with an open end of a gravity-flow drain pipe having a first width, and (ii) an open end of a second rectangular gravity-flow drain pipe having a second width, said second width being smaller than the first width, said adapter comprising:
(a) an elongate body having a first open adapter-end sized to engage with the rectangular cuff;
(b) said elongate body having a second open adapter-end;
(c) said second open adapter-end sized to engage with the open end of said second rectangular gravity-flow drain pipe.

24. The adapter of claim 23 wherein said first gravity-flow drain pipe comprises a standard, 4 inch gravity-flow drain pipe.

25. The adapter of claim 23 wherein said second gravity-flow drain pipe comprises a standard, 2 inch gravity-flow drain pipe.

26. The adapter of claim 23 wherein said first gravity-flow drain pipe comprises a standard, 4 inch gravity-flow drain pipe, and wherein said second gravity-flow drain pipe comprises a standard, 2 inch gravity-flow drain pipe.

27. The adapter of claim 23 wherein said first open adapter-end is sized to slidably engage into the rectangular cuff.

28. The adapter of claim 23 wherein said second open adapter-end is sized to slidably receive and engage said open end of said second rectangular gravity-flow drain pipe.

29. The adapter of claim 23 further comprising a locking mechanism for affixing said first open adapter-end to said rectangular cuff.

30. The adapter of claim 23 further comprising a locking mechanism for affixing said second open adapter-end to said open end of said second rectangular gravity-flow drain pipe.

31. The adapter of claim 23 further comprising an outer surface displaying a camouflage pattern.

32. The adapter of claim 31 wherein the method of producing said adapter is selected from the group consisting of texturing a mold for the pipe to create variations in the outer surface of the pipe, hydrographic printing, silk screening, spray painting, using multiple colored plastics with variations in melt temperature, in-mold labeling, applying coverings made from fabrics, applying coverings made from non-wovens, applying coverings made from plastic, embedding foreign materials in the outer surface of the pipe, or a combination of such methods.

33. The adapter of claim 23 further comprising an outer covering about the coupling, said covering having a camouflage pattern.

34. A gravity-flow drain pipe having a camouflage pattern displayed on a portion of the outer surface of the pipe.

35. The gravity-flow drain pipe of claim 34 wherein the method of producing said gravity-flow drain pipe is selected from the group consisting of texturing a mold for the pipe to create variations in the outer surface of the pipe, hydrographic printing, silk screening, spray painting, using multiple colored plastics with variations in melt temperature, in-mold labeling, applying coverings made from fabrics, applying coverings made from non-wovens, applying coverings made from plastic, embedding foreign materials in the outer surface of the pipe, or a combination of such methods.

36. The gravity-flow drain pipe of claim 34 wherein the camouflage patter comprising an outer covering about the coupling.
